(19) United States
(12) Patent Application Publication
(10) Pub. No.: US 2004/0073577 A1
(43) Pub. Date: Apr. 15, 2004

(54) Method and apparatus for implementation of a closed loop consumer incentives program

(76) Inventors: James T. Brady, San Jose, CA (US); Anthony A. Shah-Nazaroff, Santa Clara, CA (US); Scott W. Slinker, San Jose, CA (US); Steve Covington, New Braunfels, TX (US); Erik Presley, Abilene, TX (US); Mark Viertel, Abilene, TX (US)

Correspondence Address: Paul D. Greeley, Esq., Ohlandt, Greeley, Ruggiero & Perle, L.L.P., 10th Floor, One Land Mark Square, Stamford, CT, 06901-2682, US

(21) Appl. No.: 10/610,673

(22) Filed: Jul. 1, 2003

Related U.S. Application Data
(60) Provisional application No. 60/399,534, filed on Jul. 30, 2002.

(51) Int. Cl. G06F 7/00

(52) U.S. Cl. 707/104.1

(57) ABSTRACT

A system and method for the production of customer incentives at plurality dispensing station types, wherein the incentives issued at first the dispensing station of a first type are redeemed at a second the dispensing station of a second type, and wherein the incentives issued at the second dispensing station are redeemed at the first dispensing station, comprising means to identify the customer at the first and second dispensing stations; means to access a customer database containing targeted customer incentives that have been linked to the identified customer; the database having indicia linking the identified customer with specific the targeted customer incentives; means to link each the customer incentives to one or more the dispensing station types for the purpose of issuing the customer incentive; means to link each the customer incentives to one or more the dispensing station types for the purpose of redeeming the customer incentive; means to present the accessed incentives to the customer at the specific type of the dispensing stations; and means to deliver the accessed incentive to the customer at the first and second types of dispensing station.

### FIELD OF THE INVENTION

In certain retail environments there are multiple stations within the venue that dispense disparate products to customers, such as gas stations with fuel dispensers, convenience stores (C-store), and/or car washes. In these, the merchant has customers that use one dispensing station (gas dispenser) but not the other (C-store). This represents lost opportunity. Various approaches have been implemented to exploit this situation. One, AutoGas, sets up a loyalty program based on discounting fuel based on purchases in a C-store. Another, Catalina Marketing, issues coupons in grocery stores based on prior purchases. Additionally, the issuance of incentives at the fuel dispenser, in the form of coupons, has been demonstrated by Ten Square. However, these have not been combined into a self-reinforcing system where incentives at one dispensing station work in conjunction with incentives at another dispensing station in a manner that encourages the customer to continue using both dispensing stations. Of course this is not limited to venues with two types of dispensing stations.

### BACKGROUND OF THE INVENTION

This invention relates to the generation and redemption of customer incentives, such as coupon offers, electronically delivered discounts, and other certificates having value, from a variety of manufacturers, at one customer service station, and redeeming them at another customer service station, while issuing one or more incentives at the redeeming customer service station that are redeemable at the first customer service station. The most common example would be the issuance of a coupon at a C-store for a discount at the gas pump on the gas pumped, and issuing another coupon at the gas pump for potato chips that can be redeemed at the C-store.

Existing systems issue coupons at the C-store for a price rollback at the pump. This is done based on triggering purchases in the C-store, or from a customer profile based on prior purchases. The problem with this approach is there is no continuity to encourage a behavioral change in the customer, other than the customer's memory of the experience. Other systems such as the Ten Square system issue coupons selected by the customer at the gas pump. This system does not attempt to target the coupons based on the desire to drive the customer into the C-store.

Examination of the prior art shows no systems designed to encourage the looping of the customer from one Point-of-service station to another and then back to the first. Extensions of this concept beyond two Point-of-service stations have not been found. The invention herein provides a method for achieving this.

### SUMMARY OF THE INVENTION

The invention provides for a method to one or more incentives to customers at a first Point-of-sale station that can be redeemed at a second Point-of-sale station which can subsequently issue another incentive or incentives to that customer that can be redeemed at the first or third Point-of-sale station, establishing a chain of reinforcing incentives to the customer. These Point-of-sale stations are characterized by the kind of Point-of-sale station (gas pump, C-store counter, bakery department, grocery checkout, etc.), such that the incentives can be specified for delivery at a given type of Point-of-sale station type. The results rising from the issuance of an incentive is tracked by recording the issuance and redemption at the various Point-of-sale stations. Further, the results are used to build a database used to direct future distribution of incentives.

### BRIEF DESCRIPTION OF THE DRAWINGS

FIG. 1 Concept of System

FIG. 2 is a diagram of a computer System, which is adapted to perform the method of the invention.

FIG. 3 is a diagram of a computer system called the Central Server.

FIG. 4 is a diagram of a computer system called the Venue Server.

FIG. 5 is a diagram of a computer system representative of a Point-of-sale Terminal.

FIG. 6 is a data table that describes the Customer Table.

FIG. 7 Purchase Log Entry

FIG. 8 Incentive Log Entry

FIG. 9 is a Point-of-sale Terminal Table.

FIG. 10 is a drawing showing a typical Incentive

FIG. 11 describes the Bar Code Data

FIG. 12 is the Incentive Table.

FIG. 13 Predestinated Incentive Table

FIG. 14 is a data table that describes a Measurement Table.

FIG. 15 is a flow chart describing the Incentive Application.

FIG. 16 Process Transaction

FIG. 17 is a diagram that shows the Redeem Incentive process.

FIG. 18 is a flow chart describing the Issue Incentive process.

### DETAILED DESCRIPTION OF THE INVENTION

The invention is embodied in the form of a gasoline station with a convenience store. However, it applies to any retail environment having two types of Point-of-sale Terminals for handling different types of transactions. In the preferred embodiment, the checkout station in the convenience store is equipped to sell general merchandise, and the gas pump is equipped to sell gas. In a supermarket embodiment, there may be multiple types of Point-of-sale Terminals handling specific kinds of products. A supermarket is commonly configured with a checkout counter for all merchandise, a florist, a deli, and a pharmacy. In hardware stores, there may be a Point-of-sale Terminal in the tool crib as well as the ones for general checkout. One skilled in the art can apply the preferred embodiment to these and other retail environments.

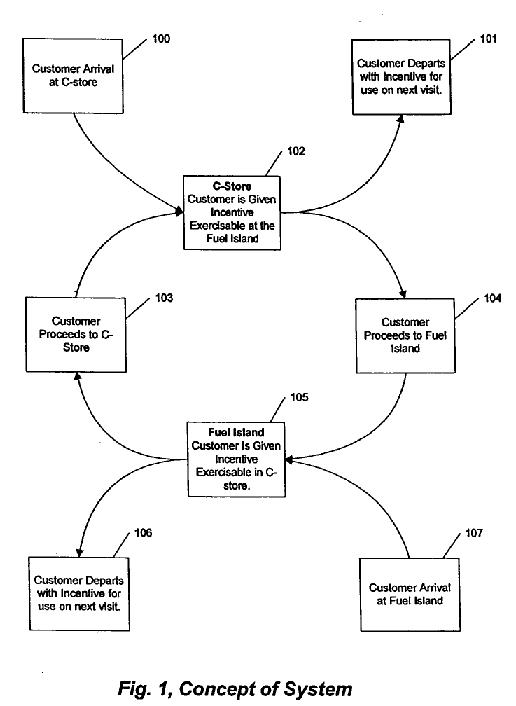

FIG. 1 is a representation of a Concept of System. Block 100 depicts the arrival of the customer at C-store 102 in a gasoline station. While in the C-store 102 the customer makes purchases or transacts other business, which may result in the issuance of one or more incentives (See FIG. 12, Incentive Table) to the customer at the FIG. 5, Point-of-sale Terminal.

An incentive is a certificate in any form (paper, electronic, etc.) that delivers value to the customer. It may be in a form carried by the customer or a form where it is maintained in the computing system that implements this invention. This incentive is exercisable at the Fuel Island 105. This encourages the customer to proceed to the Fuel Island 105, as indicated by Block 104. However, the customer may proceed as in Block 101, and depart from the gas station, having received the incentive certificate. That customer could reenter the system via Block 106 (expected) or Block 100 on the return visit.

When the customer is at Fuel Island 105, having arrived from C-store 102 or from another venue via Block 107, the incentives received in C-store 102 are redeemed. Note that if the customer arrived via Block 107, there may not have been incentives issued to that customer. During the transaction at Fuel Island 105 one or more additional incentives may be issued that can be redeemed in the C-store 102. The customer completes and either proceeds to depart the gas station, having received the incentive(s), or as in Block 103 proceeds to the C-store 102 with the incentives.

In the course of a visit, it would be normal for a customer to do business at the C-store 102, the Fuel Island 105, or both. However, the customer is not precluded from visiting either sales location multiple times and receiving and/or redeeming incentives each time. Systems may be implemented to limit the number of incentives given to a customer during one visit to the gas station.

In other embodiments the analogs of the C-store 102 and the Fuel Island 105 may be located in different venues and may be owned, managed, or controlled by other entities.

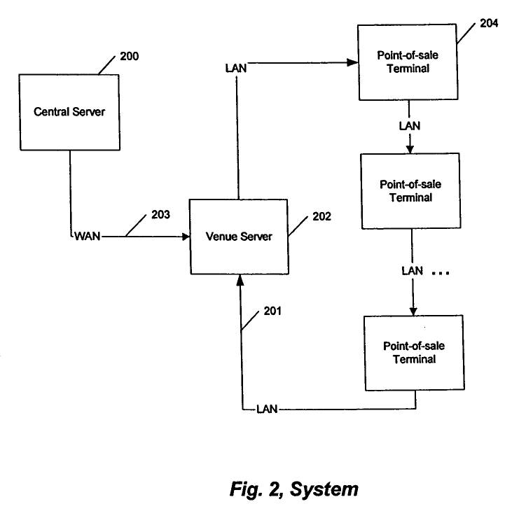

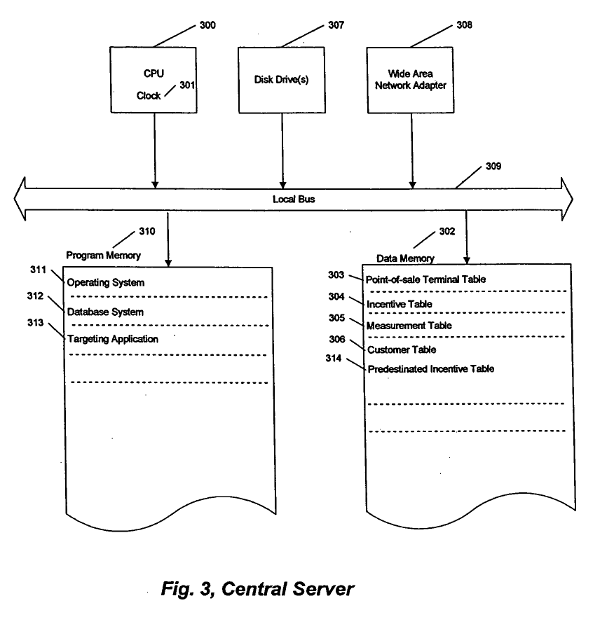

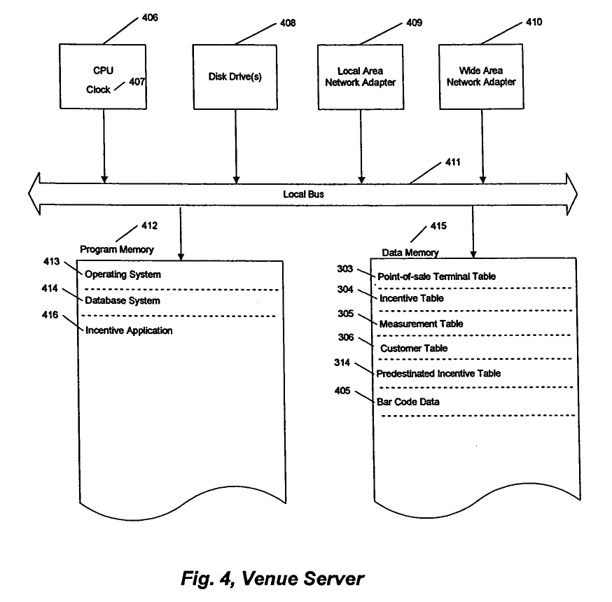

FIG. 2 described a Computing System adapted to perform the method of the invention. A Central Server 200, described in FIG. 3, is coupled by a wide area network, WAN 203 to one or more Venue Server 202. Readily available software and protocols such as TCP/IP are used by Central Server 200 and Venue Server 202, described in FIG. 4, Venue Server, to communicate with each other via WAN 203. Venue Server 202 is connected via LAN 201 to one or more Point-of-sale Terminal 204. Normal Point-of-sale Terminal activities are conducted between the Venue Server 202 and Point-of-sale Terminal 204, described in FIG. 5, Point-of-sale Terminal.

Central Server 200 is described in FIG. 3. It is the repository for incentives and performs the function of targeting and distributing incentives to specific retail venues and customers. Additionally, it collects measurements concerning the incentives and their redemption from the various Venue Servers 202. The measurements are fed back into the targeting process and are used for accounting. The functions provided in Central Server 200 in the preferred embodiment are shown in one server, but in other embodiments the function may be distributed in a plurality of servers, including Venue Server 202 and computers in Point-of-sale Terminal 204.

Venue Server 202 is located at the gas station and services Point-of-sale Terminals 204 at the Fuel Island's 105 fuel dispensers and C-store's 102 checkout counter. It provides the normal services for these and implements the distribution of incentives to the customers and accounts for the redemptions of the incentives. The functions provided in Venue Server 202 in the preferred embodiment are shown in one server, but in other embodiments the function may be distributed in a plurality of servers, including Central Server 200 and computers in Point-of-sale Terminal 204.

Point-of-sale Terminals 204 are assigned to C-store 102 and Fuel Island 1OS and service the sale of products for those and issue the incentives to the customer in printed or electronic form. They are described in FIG. 5. At the Fuel Island 105, the Point-of-sale Terminals 204 imbedded into the fuel dispenser. In the C-store 102, they take the form of conventional countertop units. The Point-of-sale Terminals 204 perform the function of delivering the incentives to the customer either in the form of a notification of an electronic certificate, or by delivering to the customer a portable certificate such as Incentive 1000 that can be redeemed to receive the incentive.

FIG. 3 illustrates further details of Central Server 200 as seen in FIG. 2, System. CPU 300 is a conventional microprocessor with a Local Bus 309 that connects it to Disk Drive(s) 307, a Wide Area Network Adapter 308, a Program Memory 310, and a Data Memory 302. Local Bus 309 may be implemented as a single bus or a system of interconnected busses. CPU 300 contains a Clock 301 that provides time in a form that includes the Month, Day-of-week, Hour, Minute, And Seconds. While this embodiment teaches a single CPU system, it is readily adapted to the various forms of multiprocessing systems.

Wide Area Network Adapter 308 is used to communicate with Central Server 200 for the communication of the various tables between Central Server 200 and Venue Server 202.

Program Memory 310 contains: Operating System 311 that controls the hardware and software that Targeting Application 313 uses; Database System 312, which manages the data for Targeting Application 313 on Disk Drive(s) 307 and in Data Memory 302; and Targeting Application 313, which distributes the Incentives 1000 to the Venue Server 202. Targeting Applications 313 have been described elsewhere and will not be further described herein.

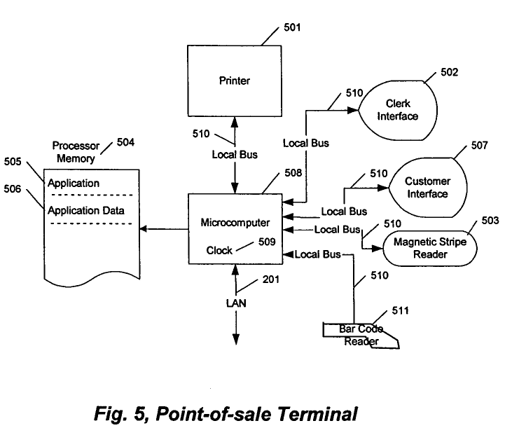

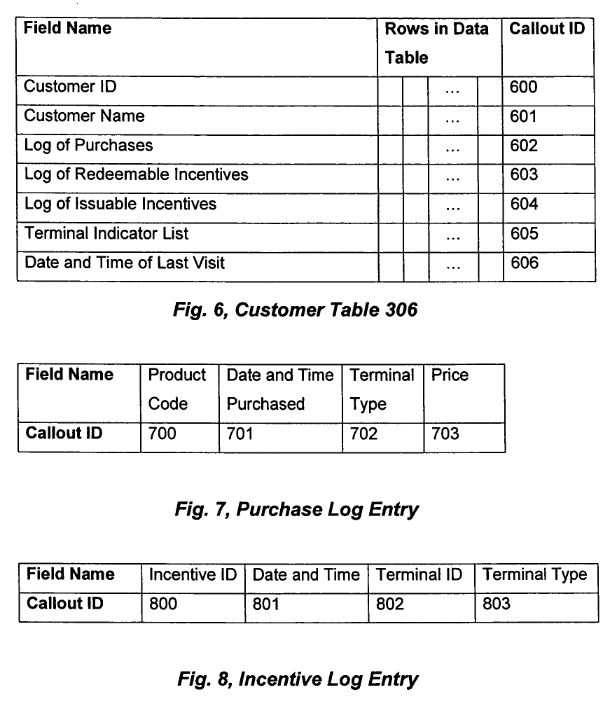

Data Memory 302 contains: Point-of-sale Terminal Table 303, which describes the Point-of-sale Terminals 204 serviced by the Venue Server 202; Incentive Table 304, which describes the Incentives 1000 that have been generated by Targeting Application 313; Measurement Table 305, which contains the data collected during the customers session with the Point-of-sale Terminal 204 (It is described in FIG. 14, Measurement Table); Customer Table 306, which contains the data items describing the customers known to visit the venue (Customer Table 306 is described in FIG. 6); and Predestinated Incentive Table 314, which contain the targeted Incentives 1000 that are generated by Targeting Application 313.

Central Server 200 performs the functions of the Targeting Application 313, which develop the Point-of-sale Terminal Table 303; Incentive Table 304, and Customer Table 306 for transmission to Venue Server 202, which delivers the incentives to the Point-of-sale Terminals 204 and returns the Measurement Table 305. This communication is done via WAN 203 using Wide Area Network Adapter 308.

FIG. 4. Venue Server is a representation of a typical server in a venue as seen in FIG. 2, System. Venue Server performs the functions required in a Point-of-sale system that are in support of Point-of-sale Terminal 204 in a location. CPU 406 is a conventional microprocessor with a Local Bus 411 that connects it to Disk Drive(s) 408, a Local Area Network Adapter 409, a Wide Area Network Adapter 410 (which attaches to LAN 201 for communications with Venue Server 202), a Program Memory 412, and a Data Memory 415. CPU 406 contains a Clock 407 that provides the capability to generate time and date information.

Program Memory 412 contains: Operating System 413 that controls the hardware and software that Incentive Application 416 uses; Database System 414, which manages the data for Incentive Application 416 on Disk Drive(s) 408 and in Data Memory 415; and Incentive Application 416, which performs the method of this invention.

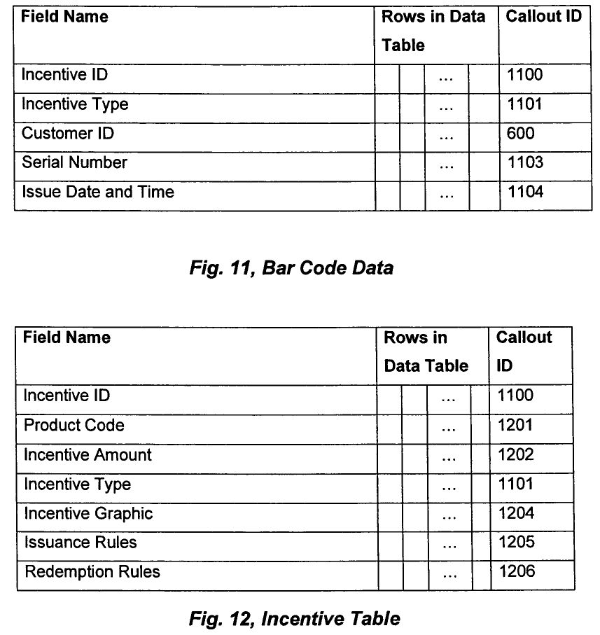

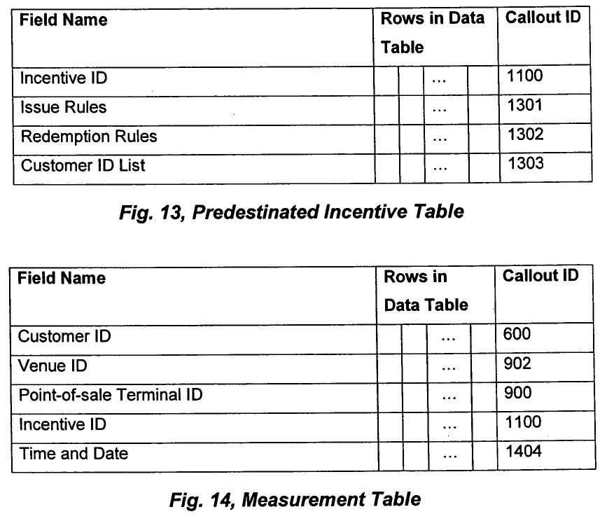

Data Memory 415 contains: Point-of-sale Terminal Table 303, which describes the Point-of-sale Terminals 204 serviced by the Venue Server 202; Incentive Table 304, which describes the Incentives 1000 currently resident in the Venue Server 202 that can be issued or redeemed; Measurement Table 305, which contains the data collected during the customers session with the Point-of-sale Terminal 204 (Measurement Table 305 is described in FIG. 14, Measurement Table); Customer Table 306, which contains the data items describing the customers known to visit the venue (Customer Table 306 is described in FIG. 6, Customer Table); Predestinated Incentive Table 314, containing the list of targeted incentives for the venue (Predestinated Incentive Table 314 is described in FIG. 13, Predestinated Incentive Table); and Bar Code Data 405, which is generated by Incentive Application 416 when issuing an Incentive 1000 (Bar Code Data 405 is described in FIG. 11, Bar Code Data).

FIG. 5 is a diagram of a Point-of-sale Terminal seen in FIG. 2. Point-of-sale Terminals 204 are configured with a Microcomputer 508 of conventional design. Microcomputer 508 contains a Clock 509 that provides time in a form that includes time and date capability. Attached to the Microcomputer 508 are various input and output devices including: a LAN 201, Printer 501, Clerk Interface 502, Customer Interface 507, Magnetic Stripe Reader 503, and Bar Code Reader 511. These are attached via electronic Local Bus 510 links, which normally are serial IO like an RS232 serial port. Customer Interface 507 is used for presenting the incentives to the Customer and receiving responses. As such, it can contain information displays and manual input capability in the form of a touch screen or keys. Magnetic Stripe Reader 503, Bar Code Reader 511, and Customer Interface's 507 touch screen, or keys, are sources for the input of the Customer ID 600. In cases where the Incentives 1000 are to be automatically delivered, Customer Interface 507 is not required to be a part of Point-of-sale Terminal 204. In addition, in special forms of Point-of-sale Terminal 204 that are unattended, such as a gas pump, Clerk Interface 502 is not required. Printer 501 is used to print receipts and Incentives 1000. When Incentives 1000 are delivered by an electronic representation, Printer 501 is not required for the printing of Incentives 1000.

Processor Memory 504 contains Application 505 and Application Data 506 needed to run FIG. 5, Point-of-sale Terminal. Application 505 is a conventional application for the specific type of Point-of-sale Terminal 204 that has been augmented with the capability to print Incentives 1000 and to pass communications to and from the customer at Customer Interface 507 and Venue Server 202. Application Data 506 consists of the data required to run a conventional application for the specific type of Point-of-sale Terminal 204 that has to be augmented with data to be presented on the Customer Interface 507, printed on Printer 501, and received from the Customer Interface 507 or Magnetic Stripe Reader 503 in support of Incentive Application 416 in Venue Server 202.

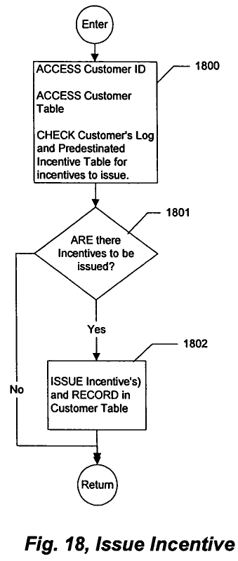

FIG. 6 illustrates Customer Table that contains a Customer ID 600 which is the ID provided to the retailer by the Customer in the course of the primary transaction being performed. It may be a credit card number or other ID, or no ID (anonymous ID). It also contains Customer Name 601, Log of Purchases 602, Log of Redeemable Incentives 603, and Log of Issuable Incentives 604a. Log of Purchases 602 is used by the various rules in determining which incentives to issue; Log of Redeemable Incentives 603 is the mechanism that allows specific Incentives 1000 to be tied to a individual customer. It is built by FIG. 18, Redeem Incentive. Log of Issuable Incentives 604 is a list of Incentives 1000 that have been designated for this customer by Targeting Application 313 or by FIG. 18, Issue Incentives. Terminal Indicator List 605 is used to keep track of what Point-of-sale Terminals 204 the customer has used during the current visit to the venue. This is done by storing Point-of-sale Terminal ID 900 in this list. In this embodiment, the list is implemented as a chained list of data blocks. In other embodiments, the indicators can be implemented by fixed fields or using techniques such as tree structures. Date and Time of Last Visit 606 is used to determine if Customer Table 306 is to be reinitialized. Customer Table 306 is provided by Central Server's 200, Targeting Application 313.

FIG. 7 is a representation of an Purchase Log Entry, comprised of: Product Code 700, which contains a UPC for the product or a stocking code; Date and Time Purchased 701, is the date the customer purchased the product; Terminal Type 702, which is the terminal type that executed the sale; and Price 703 is what the customer paid for the product. FIG. 7, Purchase Log Entries are used by the various rules governing the issue and redemption of incentives.

FIG. 8 is a representation of an Incentive Log Entry which contains: Incentive ID 800, identifying the incentive; Date and Time 801, which relates to the time of issue of the incentive or the expiration date, depending on whether the entry is in the Log of Issuable Incentives 604 or the Log of Redeemable Incentives 603; Terminal ID 802, which specifies the terminal ID of the issuing terminal; and Terminal Type 803, which specifies the terminal type for the issuing terminal when used in the Log of Issuable Incentives 604, or as the type of terminal that can be involved in the redemption when used in the Log of Redeemable Incentives 603. FIG. 8, Incentive Log Entries are used by the various rules governing the issue and redemption of incentives.

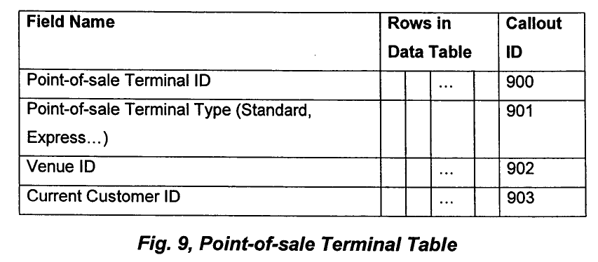

FIG. 9 is Point-of-sale Terminal Table which consists of: Venue ID 902, which is used in Targeting Application 313 to identify the venue; Point-of-sale Terminal ID 900, which contains a unique identifier for each Point-of-sale Terminal 204 with in the venue; Point-of-sale Terminal Type 901 (Checkout Counter, Express Checkout, Gas Pump, Car Wash,), which contains a code describing the type for the Point-of-sale Terminal 204 having the Point-of-sale Terminal ID 900 in this entry; and Current Customer ID 903, which contains a copy of Customer ID 600, when a customer is being processed by the terminal. When the table is generated by Targeting Application 313, Current Customer ID 903 is not supplied. It is provided by Incentive Application 416 when the customer has been identified at Point-of-sale Terminal 204 during the transaction. If identification is not provided by the customer, as would be the case with a cash customer, a special code is used to indicate an anonymous customer.

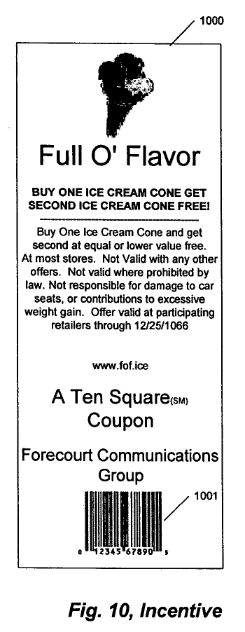

FIG. 10 is a representation of an Incentive 1000 in the form of a coupon offer. Many forms of Incentives 1000 are possible including: cash rebates, fixed amounts off, percentage discounts, buy one or more products and get one or more products discounted, and buy a product and get a discount on a service. On a printed certificate, Bar Code 1001 contains the data, as described in FIG. 11, Bar Code Data, for the Incentive 1000. The preferred embodiment uses a paper form of the Incentive 1000, while other embodiments are in the form of coupons encoded on magnetic striped cards, smart cards and their analogs, and electronic certificates.

FIG. 11 is a representation of a Bar Code Data, consisting of the Incentive ID 800 and Incentive Type 1101, which are copied from FIG. 12, Incentive Table when the Incentive 1000 is created; Customer ID 600, which is copied from Current Customer ID 903; and Serial Number 1103 which is generated by Incentive Application 416 at the time the Incentive 1000 was created. Issue Date and Time 1104 contains the data and time the incentive was issued. This is used in: checking redemption expiration rules that are encoded in Redemptions Rules 1206 and Redemption Rules 1302; and execution of linked incentive rules encoded in Issuance Rules 1205 or Issue Rules 1301. This data is described as embodied in a bar code on Incentive 1000. In other embodiments, it may be encoded in smart cards or similar devices, on the magnetic stripe of a customer ID card, as a file stored on the Venue Server 202 and accessed by a customer ID or code.

FIG. 12 is an Incentive Table, which contains the descriptions of the various Incentives 1000. The specific Incentive 1000 is selected based on the Customer ID 600 currently being serviced by a Point-of-sale Terminal 204. FIG. 12, Incentive Table, entries are downloaded periodically from Central Server 200, and contain Incentive ID 800, which contains a unique ID for each Incentive 1000 resident in the venue; Product Code 700, which is a unique identifier for the product involved in the incentive. It would contain the UPC (Universal Product Code) or stocking number of the product; Incentive Amount 1202, which contains a numeric value indicating the value of that incentive in the form of a percentage discount or a number of monetary units; the form of the field is depended on Incentive Type 1101, which identifies the type of incentive (coupon, percentage discount, amount per volume discount, etc.) and whether it was a presentation, issuance, or redemption of Incentive 1000; Incentive Graphic 1204, which contains a representation of the graphic used in presenting the Incentive 1000; Issuance Rules 1205, which describe the customers or customer behavior that trigger the issuance of an incentive; and Redemption Rules 1206, which describe the conditions under which the customer may redeem the Incentive 1000. Issuance Rules 1205 and Redemption Rules 1206, in this embodiment are in the form of “regular expressions” (see: Mastering Regular Expressions Powerful Techniques for Perl and Other Tools, By Jeffrey E. F. Friedl, 1st Edition, January 1997, ISBN -1-56592-257-3, O'Reilly Books)

A set of rules like:

Start:

Remove Expired_Incentives from Log_of_Redeemable_Incentives
Then

If Point-of-sale_Terminal_Type = “gas pump”

And

If Log_of_Redeemable_Incentives Contain (“gas offer”)

Then apply “gas offer” to Price and Remove “gas offer”
from Log_of_Redeemable_Incentives

If Gas_Sale Complete

Then Issue_Incentive (gallons_delivered, grade)

End.

This rule removes elapsed incentives from Log of Redeemable Incentives 603. Then it runs in parallel two rules. The first finds out if the purchase is happening at a gas pump so it can apply any incentives that apply to gas pumps. If it does, then it will access the incentive from the Log of Redeemable Incentives 603 to get the information about the incentive and to remove the incentive from the log. The second rule requests the issuance of an incentive after the transaction has completed, and the quantity of gas sold and its grade are known. The next set of rules is triggered by this rule.

Start:

Issue_Incentive:

Execute Incentive_Rules
Select Eligible Incentives
Add Incentives to Log_of_Redeemable_Incentives
Print Incentives

End

This rule causes all of the Issuance Rules 1205 in the Incentive Table 304. As these are executed the rules will determine if the incentives are “eligible.” If so, they are marked that way. Then the eligible incentives go through another set of rules to select a subset of these for issue to the customer. The ones selected are added to Log of Redeemable Incentives 603 for that customer, and the incentives are printed in the form of Incentive 1000 or its alternative embodiments.

The Execute Incentive_Rules causes rules such as the one below to be executed. Each incentive has its own set of rules, which may be unique to the incentive.

Start:

Typical Incentive_Rule

Weight = 10
Value = 10
If at “gas pump”
Then

If Log_of_Purchases Contains (“Crispy Chips”,
“Haggen's Pop”) Then

Increment (Weight = +3)

If Date_and_Time_of_Last_Visit Before Yesterday
Then

Increment (Value ,20) and Increment (Weight, Today -
Date_and_Time_of_Last_Visit)

If Log_of_Purchases Contains ((Product_Code_1,
Product_Code_2) and (Product_Code_3))
Having Terminal_Type = “C-store”
Then

If Weight > 8

Then

Make Incentive_ID = “Incentive_X” Eligible
With Value.

End

The rule starts by initializing parameters, then checks to see if the customer is at the gas pump. If not, the rule does not fire. If it is at the gas pump, then a number of rules are run in parallel. In the first the Log of Purchases 602 for the customer is examined to find triggering products on the log, which trigger an increase in the Weigh parameter.

In the second it is determined if the customer's last visit had been more than a day ago. If so, the Value and Weight parameters are changed to reflect that.

The third rule checks the Log of Purchases 602 for the customer to determine if a specific combination of product codes were purchased in the C-store and if the Weight exceeds 8, the incentive is made eligible with a parameter of Value.

In this manner a variety of functions can be built that tie issuance of Incentives 1000 to a large number of parameters including: products purchased, the timing of events, location of purchase, incentives redeemed, day of events, time of events, and the rapidity of redemption of Incentives 1000.

FIG. 13 is a representation of a Predestinated Incentive Table 314, which consists of: Incentive ID 800, relating the entry to a specific Incentive 1000; Issue Rules 1301, which are rules in the form of regular expressions that determine when the incentive having Incentive ID 800 is to be issued; Redemption Rules 1302, which are rules in the form of regular expressions that determine when the incentive having Incentive ID 800 is to be redeemed; and Customer ID List 1303, which is a list of Customer IDs 600 that are to receive the specified incentive.

FIG. 14 is an Measurement Table that describes the information collected in the Venue Server 202 that is used to account for the issuance and redemption of the incentives and to provide information that drives the loyalty programs and targeting programs. It is composed of: Customer ID 600, which identifies the customer that received Incentive 1000 with Incentive ID 800; Venue ID 902, which identifies the venue where the activity took place; Point-of-sale Terminal ID 900, which identifies the Point-of-sale Terminal 204 involved in the transaction; and Time and Date 1404, which specifies the time and date of the transaction. This information is generated in Venue Server 202 by Targeting Application 313 and transmitted to Targeting Application 313 in Central Server 200 via WAN 203.

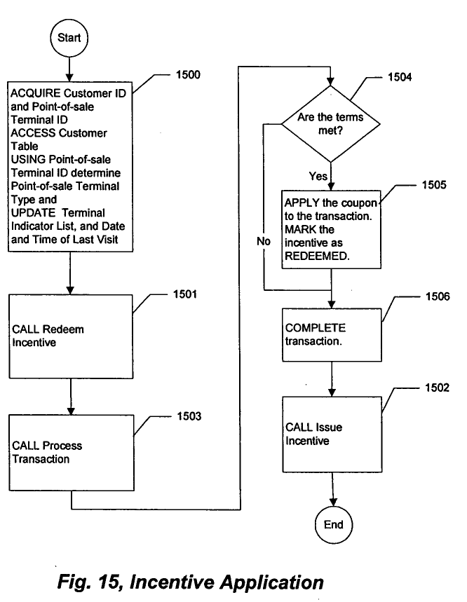

FIG. 15 is a flow chart for Incentive Application 416, which starts at Step 1500. Step 1500 access the Customer ID from a loyalty card, bankcard, or other source of identification. The Customer ID is used to access the Customer Table 306. The Point-of-sale Terminal ID 900 from the Point-of-sale Terminal 204 used by the customer is accessed from the Point-of-sale system and used to access the Point-of-sale Terminal Table 303. Point-of-sale Terminal ID 900 is used to update the Terminal Indicator List 605 by checking the current date and time from Clock 407 against the Date and Time of Last Visit 606. If the difference is more than a predestinated amount, the list is cleared and the current Point-of-sale Terminal ID 900 is entered into the list, and the Date and Time of Last Visit 606 is set to value accessed from Clock 407.

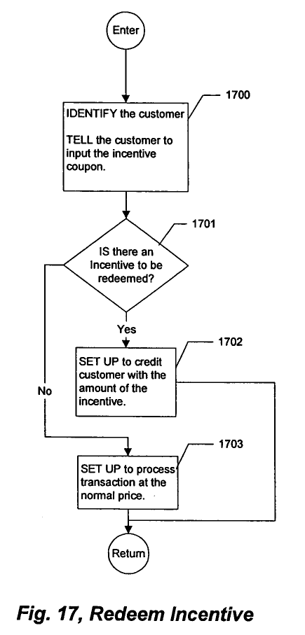

Control is then passed to Step 1501, which calls the FIG. 17 Redeem Incentive routine. Upon return from that, routine control passes to Step 1503, which calls the FIG. 18, Process Transaction routine. Upon return, control passes to Step 1504.

Step 1504 determines if the conditions for redeeming the coupons are met by running the Redemption Rules 1206 for the list of FIG. 12, Incentive Table entries returned by the FIG. 17, Redeem Incentive routine. If so, control passes to Step 1505; otherwise control passes to Step 1506.

Step 1506 applies the value of the Incentive 1000 by reducing the price of the items as indicated by the Incentive Type 1101 and Incentive Amount 900a. It then accesses the Log of Redeemable Incentives 603 and updates it to indicate the redemption. Control is then passed to Step 1502.

Step 1502 completed the customer's transaction as part of the normal Point-of-sale Terminal application. Then control passes to Step 1502, which calls the FIG. 18, Issue Incentive routine. When that routine returns control, the process is ended.

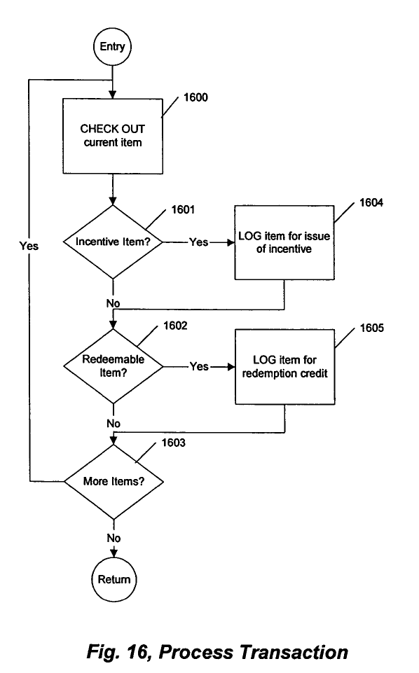

FIG. 16 is the Process Transaction routine, which starts with Step 1600. This is the first step of a loop which processes each item the customer is purchasing at the Point-of-sale Terminal 204. After the current item is processed by the checkout application, control passes to Step 1601 which checks to see if the item's product code matches Product Code 700 of an entry in Incentive Table 304. If so, the Incentive Type 1101 is checked. If the Incentive Type 1101 requires the issuance of an Incentive 1000, control passes to Step 1604; otherwise, control passes to Step 1602.

Step 1602 checks the Incentive Table 304, associated with the Product Code 700 to determine if the Incentive Type 1101 allows redemption of a previously issued Incentive 1000. If so, control passes to Step 1605; otherwise control passes to Step 1603.

Step 1603 is the end of the checkout loop. It determines if there are more items to checkout. If so, control passes to Step 1600; otherwise the routine returns to the calling program.

This routine represents the normal checkout process. These are represented by Step 1600 and Step 1603. Step 1601, Step 1602, Step 1604, and Step 1605 represent the augmentation required to embody this invention.

FIG. 17 is a diagram showing the Redeem Incentive routine. It starts with Step 1700, which acquires the Customer ID 600 from one of the customer input devices associated with the Point-of-sale Terminal 204 that the customer is using or via the Clerk Interface 502. Then the customer is asked to input the information concerning the various Incentive 1000 to be redeemed. In this embodiment, the customer uses the Bar Code Reader 511, Magnetic Stripe Reader 503, or Customer Interface 507 to input the information as represented in FIG. 11, Bar Code Data. In other embodiments the information could be transferred from Smart Cards and similar radio based devices, by manual entry by the clerk, by photonic means, by input of a Customer ID 600, which is used to access the information electronically, and other such mechanisms that can transfer information or customer identification. Control then passes to Step 1701.

Step 1701 accesses the Customer Table 306 and checks Log of Redeemable Incentives 603, using that to access Incentive Table's 304, Incentive Type 1101. Incentive Type 1101 is used to determine if the Incentive 1000 is a redeemable incentive. If so, control passes to Step 1702; otherwise control passes to Step 1703.

Step 1702 logs the credit for Incentive 1000 for redemption in a later stage of the process as described in Step 1505. The routine then returns to the calling routine.

Step 1703 sets an indicator for Step 1505 that there are no Incentive's 1000 to be redeemed, and then returns to the calling routine.

FIG. 18 is a flow chart describing the Redeem Incentive process. It starts with Step 1800 which accesses the Customer ID 600 as supplied by the calling routine. It then uses Customer ID 600 to access Customer Table 306 for use in subsequent steps. Then the Log of Issuable Incentives 604, as updated in Step 1604, is checked and if there are incentives to be issued. These are checked by executing the Issuance Rules 1205 for each of the Incentives 1000 in the Log of Issuable Incentives 604a. Next, the Predestinated Incentive Table's 314, Redemption Rules 1302 are executed. The incentives found to be issuable by these are queued in Log of Issuable Incentives 604, for Step 1802 to issue. Then control passes to Step 1801.

Step 1801 passes control to Step 1802 if there are Incentives 1000 to issue; otherwise the routine returns to the calling routine.

Step 1802 processes the Log of Issuable Incentives 604 by preparing FIG. 11, Bar Code Data for each, encoding that data for the media used to issue the Incentive 1000, and attaching the data to the Incentive 1000. In the case of a printed coupon, as embodied in Incentive 1000, the FIG. 11, Bar Code Data is printed as Bar Code 1001. The Incentive 1000 is then printed or otherwise distributed to the customer. A record of the incentive is made in Customer Table's 306, Log of Redeemable Incentives 603. Control is then returned to the calling program.

What is claimed is:

1. A system for the production of customer incentives at a plurality dispensing station types, wherein the incentives issued at first said dispensing station of a first type are redeemed at a second said dispensing station of a second type, and wherein the incentives issued at said second dispensing station are redeemed at said first dispensing station, comprising:
means to identify said customer at said first and second dispensing stations;
means to access a customer database containing targeted customer incentives that have been linked to said identified customer;
said database having indicia linking said identified customer with specific said targeted customer incentives;
means to link each said customer incentives to one or more said dispensing station types for the purpose of issuing said customer incentive;
means to link each said customer incentives to one or more said dispensing station types for the purpose of redeeming said customer incentive;
means to present said accessed incentives to said customer at said specific type of said dispensing stations;
means to deliver said accessed incentive to said customer at said first and second types of dispensing station.

2. A system as in claim 1, where further means are provided for a second customer incentive type, which can be issued at either of said first and second dispensing station types, and is not tied to a specific said dispensing station type.

3. A system as in claim 1, where said incentives are coupons.

4. A system as in claim 1, where said incentives are a percentage off on the total purchase at said dispensing station redeeming said incentive.

5. A system as in claim 1, where said incentives are a percentage off on specific products at said dispensing station redeeming said incentive.

6. A system as in claim 1, where said incentives are a specific amount off, per unit of the dispensed product's price.

7. A system as in claim 1, where said incentives are certificates that can be redeemed for services.

8. A system as in claim 1, where said plurality of dispensing station types are located at the same venue.

9. A system as in claim 1, where one or more of said plurality of dispensing station types are located at a plurality of venues.

10. A system as in claim 1, where said first and second dispensing station type are owned, controlled, or managed by the same entity.

11. A system as in claim 1, where said first and second dispensing station types are owned, controlled, or managed by a plurality of entities.

12. A system as in claim 1, where said incentives are characterized to allow selection of a first said incentive to said customer in a manner that increases the probability said customer will revisit said issuing dispensing station as a result of receiving a second said incentive at said second type of dispensing station coincident with the visit where said first said incentive was redeemed.

13. A system as in claim 11, where incentives are selected to result in additional iterations of the issuing and redemption of said characterized incentives resulting in a loop of said issuing and redemption among a plurality of said dispensing stations.

14. A system as in claim 1, where further means are provided to allow selection of said incentives by use of a targeting database.

15. A system as in claim 1, where further means are provided to couple said incentive issued at said first dispensing station type with said incentive issued at said second dispensing station type such that the probability of redemption of both said incentives is increased.

16. A system as in claim 1, where further means are provided such that said first dispensing station type, and said second dispensing station type are of the same said type.

17. A method for producing customer incentives at a plurality dispensing station types, wherein the incentives issued at first said dispensing station of a first type are redeemed at a second said dispensing station of a second type, and wherein the incentives issued at said second dispensing station are redeemed at said first dispensing station, comprising:
identifying said customer at said first and second dispensing stations;
accessing a customer database containing targeted customer incentives that have been linked to said identified customer; wherein said database comprises an indicia linking said identified customer with specific said targeted customer incentives;
linking each said customer incentives to one or more said dispensing station types for the purpose of issuing said customer incentive;
linking each said customer incentives to one or more said dispensing station types for the purpose of redeeming said customer incentive;
presenting said accessed incentives to said customer at said specific type of said dispensing stations; and
delivering said accessed incentive to said customer at said first and second types of dispensing station.
